(19) United States
(12) Patent Application Publication
(10) Pub. No.: US 2002/0028416 A1
(43) Pub. Date: Mar. 7, 2002

(54) Orthodontic bracket

(76) Inventor: Harry Lerner, Caracas (VE)

Correspondence Address: PILLSBURY WINTHROP LLP, 1600 TYSONS BOULEVARD, MCLEAN, VA, 22102, US

(21) Appl. No.: 09/879,039

(22) Filed: Jun. 13, 2001

Related U.S. Application Data
(60) Provisional application No. 60/211,226, filed on Jun. 13, 2000.

(51) Int. Cl. A61C 3/00

(52) U.S. Cl. 433/16; 433/11

(57) ABSTRACT

An orthodontic bracket defining a wire guide therethrough is described. The bracket includes first and second planar surfaces in the wire guide. The first planar surface is disposed at a predetermined angle from the second planar surface so that the first and second planar surfaces act as stops to limit tipping of the bracket when either planar surface abuts a wire disposed through the wire guide. In this manner the bracket incorporates stops to prevent the over-correction of a tooth during an orthodontic procedure.

This application relies for priority on U.S. Provisional Patent Application Ser. No. 60/211,226, entitled “IMPROVED ORTHODONTIC BRACKET,” which was filed in the name of Dr. Harry K. Lerner on Jun. 13, 2000. The contents of that application are incorporated herein by reference.

### FIELD OF THE INVENTION

The present invention concerns an improvement to an orthodontic bracket. In particular, the present invention concerns the shape of a channel that forms the bottom portion of a wire guide through the orthodontic bracket. More specifically, the improvement is directed to the shape of the surface of the bottom portion of the wire guide that contacts a wire disposed therethrough. The bracket is designed to be used with the commonly known light wire and edgewise corrective techniques, either singly or in combination.

### BACKGROUND OF THE INVENTION

The Applicant for the present invention is also the patentee for the following three patents, U.S. Pat. No. 5,037,297, U.S. Pat. No. 4,941,825, and U.S. Pat. No. 4,838,787. All three patents describe orthodontic brackets of a type known in the prior art. All three patents are incorporated herein by reference.

In conventional orthodontic treatments, two methods of treatment are primarily used. The first technique is known as the edgewise technique, which consists of applying moving force to the tooth by the use of a bracket having a rectangularly sectioned arch wire receiving slot with an arch wire received therein. The tooth is moved by the application of angular torque to the bracket by the square sectioned arch wire. This torque is transferred to the underlying tooth, attached to the bracket, which then moves in the desired direction. A variation on the edgewise technique is the straight wire technique. In the straight wire technique, the torque and angulation are preadjusted in the bracket.

The second technique uses a lighter wire and is known as the Begg light wire technique. This technique is characterized by the application of a light, round-sectioned arch wire, the force being applied to the tooth bracket by a different form of attachment of the light wire to the bracket. The result is similar to that of the rectangularly sectioned arch wire in that the energy stored in the wire by spring means is transferred to the tooth over time. It is very useful to have the versatility of a combination bracket that allows the use of either technique singly or both techniques simultaneously.

In prior art orthodontic brackets 200, such as the ones described in U.S. Pat. Nos. 5,037,297, 4,941,825, and 4,838,787, it is known to include a curved surface 202 for the wire guide 25 that contacts a wire 40 at a single point under that wire 40. (See generally FIG. 1.) As shown, the wire 40 extends through the wire guide 25 at a position toward the top of the bracket 200 to provide orthodontic correction according to the Begg light wire technique, to which reference is made in U.S. Pat. No. 5,037,297 at col. 1, lines 31-32.

Since the surface 202 contacts the wire 40 at only one point 204, the curved surface 202 permits tooth 206 to tip as it moves into a predetermined orthodontic position in the patient's mouth. (See, e.g., FIGS. 2 and 3.) The starting angular orientation 208 of the tooth 206, in relation to the horizontal, is show in FIG. 2, attached. As tooth 206 moves in the patient's mouth, however, the tooth 206 changes its angular position to an alternative angular position 212, as shown in FIG. 3.

Because bracket 200 provides a curved surface 202, the wire 40 that it contacts is permitted to move in relation to the curved surface 202 as the angular orientation of the tooth changes. Accordingly, regardless of the angular orientation of tooth 206 with respect to the horizontal, the wire 40 can apply whatever orthodontic force is needed to move tooth 206 into a desired position without interfering with the operation of bracket 200. As illustrated in FIG. 1, the wire 40 is held onto bracket 200 by elastomeric ringlet 210, for example. Other attachment techniques also may be used, as illustrated in U.S. Pat. Nos. 5,037,297, 4,941,825, and 4,838,787 for example.

One of the disadvantages of incorporating the curved surface 202 on the bracket 200, however, is that, in some instances, the curved surface 202 may permit the tooth 206 to over-tip. In other words, where a curved surface 202 is incorporated into the bracket 200, it is possible to overcorrect the angular orientation of the tooth 206. If it tips too far, the tooth 206 will require subsequent orthodontic attention to readjust the tooth's angular orientation. The tooth 206 may tip too far if the patient fails to show-up for his or her regularly-scheduled orthodontic appointments, for example.

It is, therefore, a failing in the prior art that permits orthodontic overcorrection of the angular orientation of a tooth.

### SUMMARY OF THE INVENTION

Accordingly, a need has arisen for an orthodontic bracket that prohibits orthodontic overcorrection. In other words, a need has developed for an orthodontic bracket that provides a stop to prevent the tooth to which the bracket is attached from tipping too far during the orthodontic procedure.

In addition, because the orthodontic bracket must permit the tooth to change its angular orientation during the orthodontic procedure, a need has arisen for an orthodontic bracket that provides the convenience of a surface that contacts the wire at only one point. (This is known as “one point contact” for the Begg light wire technique.)

It is an object of the present invention to provide a bracket for orthodontic care that can be used with the Begg light wire technique but that also incorporates a stop to prevent the tooth connected thereto from tipping too far during an orthodontic procedure.

### BRIEF DESCRIPTION OF THE DRAWINGS

For a better understanding of the present invention as well as other objects and further features thereof, reference is made to the following description which is to be used in conjunction with the accompanying drawings. Common reference numerals are used in the various figures to designate the same structure, in which:

FIG. 1 is a perspective illustration of a prior art orthodontic bracket;

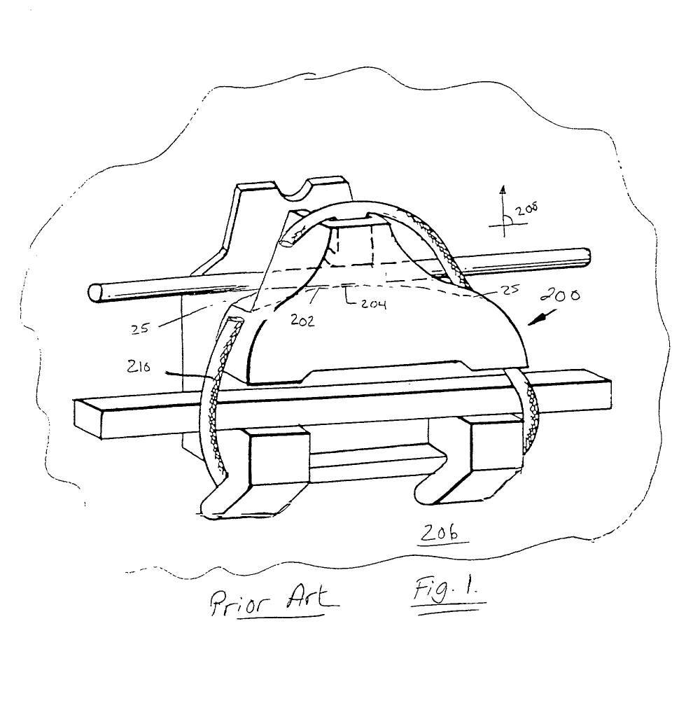

FIG. 2 is a partial cross-sectional view of the bracket shown in FIG. 1, illustrating a starting orientation of the bracket in relation to the wire;

FIG. 3 is a partial cross-sectional view of the bracket shown in FIG. 1, illustrating the contact position of the wire to the bracket after the underlying tooth has changed its angular orientation;

FIG. 4 is a perspective illustration of the orthodontic bracket of the present invention;

FIG. 5 is a partial cross-sectional view of the orthodontic bracket shown in FIG. 4, illustrating a starting orientation of the bracket in relation to the wire;

FIG. 6 is a partial cross-sectional view of the orthodontic bracket shown in FIG. 4, illustrating a maximum contact angle between the wire and the bracket; and

FIG. 7 is a partial cross-sectional view of a variation of the orthodontic bracket illustrated in FIG. 5 and FIG. 6, illustrating a variation on the maximum contact angle between the wire and the bradket.

### DESCRIPTION OF THE PREFERRED EMBODIMENTS

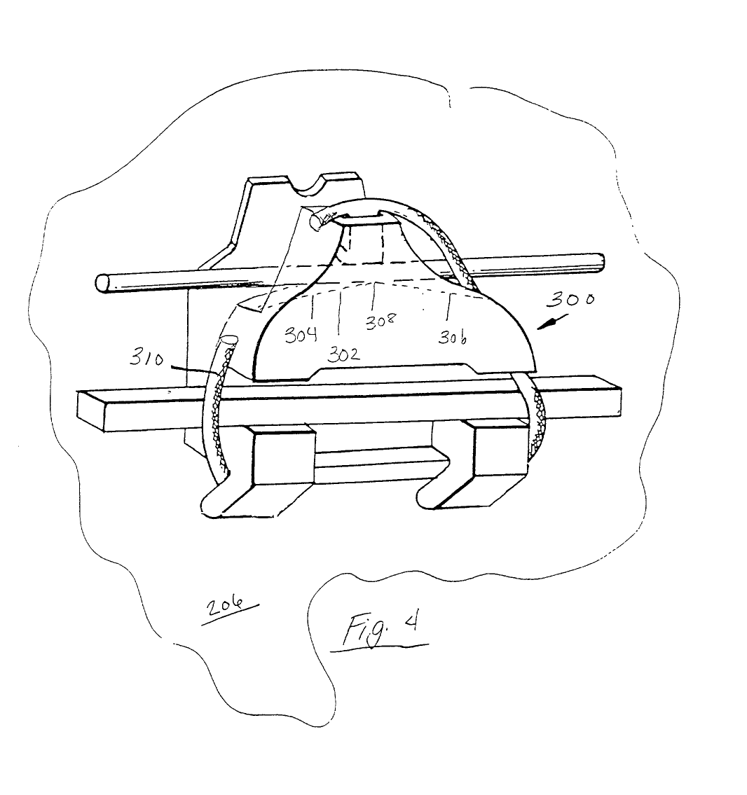

To accomplish the objectives set forth above, the bracket 300 of the present invention (and a variation of bracket 300, which is labeled as bracket 400) includes a surface 302 that has an inverted v-shape. As illustrated in FIGS. 4-6, the inverted v-shaped surface 302 has two generally planar surfaces 304, 306 that meet one another at an apex 308. Wire 40 is positioned in the bracket 300 (in the Begg light wire technique) so that wire 40 is held against apex 308. Wire 40 may be held in place by any technique known to those skilled in the art. For example, wire 40 may be held against apex 308 by a suitable elastomeric ringlet 310.

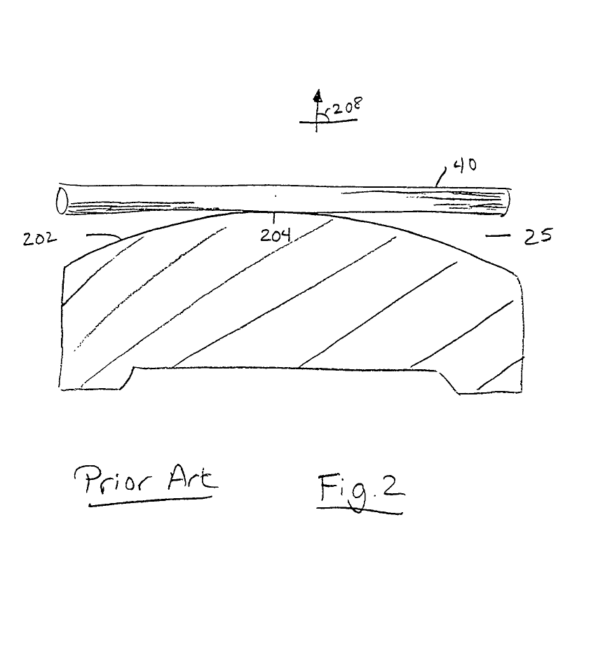

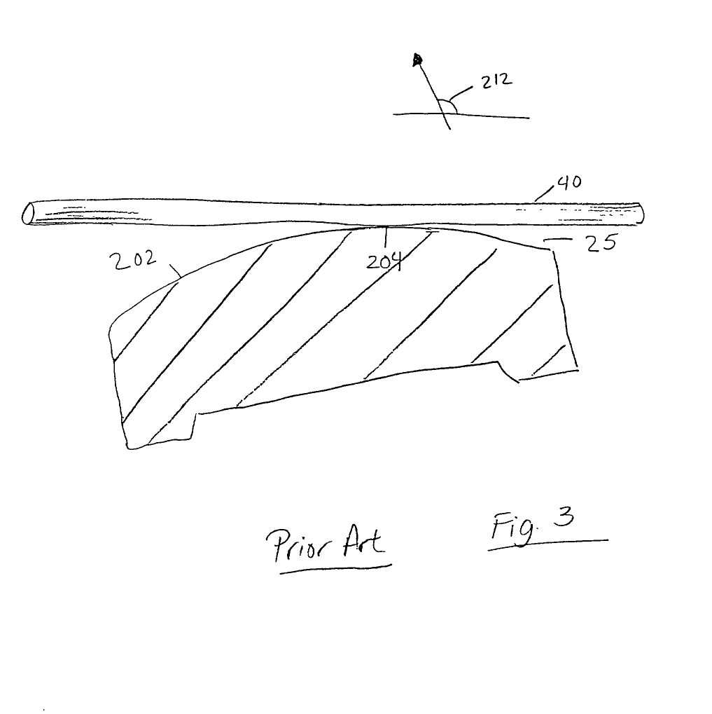

Since wire 40 is held in place against apex 308, it advantageously contacts bracket 300 at a single location (like wire 40 contacts curved surface 202 on bracket 200). As a result, wire 40 may “rock” in either direction as tooth 206 changes its angular position over time. (See, e.g., FIGS. 2-3.) However, planar surfaces 304, 306 provide stop positions to prevent tooth 206 from tipping past a predetermined angular position. In other words, tooth 206 may not tip to an angular position that exceeds the limit provided by either planar surface 304, 306.

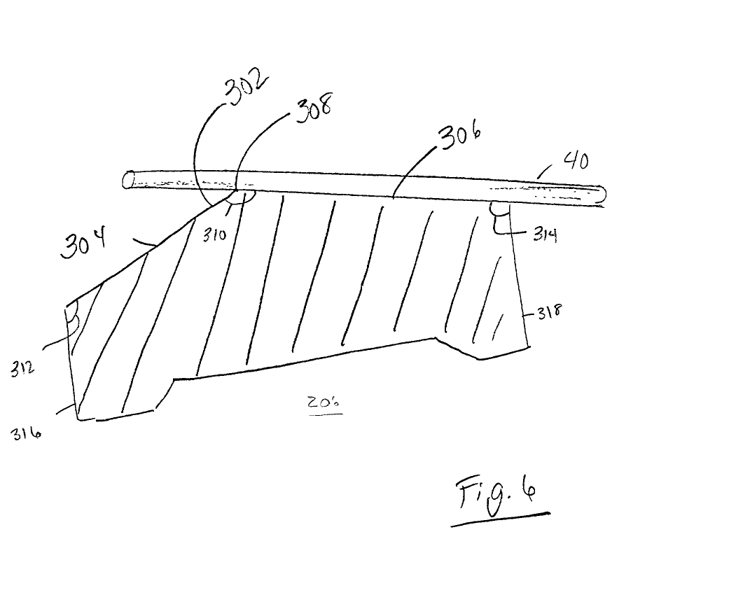

As illustrated in FIG. 6, if tooth 206 tips to point where wire 40 rests on planar surface 306, it cannot tip further. The planar surface 306, therefore, acts as a stop (or limit) to prevent the tooth 206 from tipping too far from a predetermined position during a typical orthodontic corrective procedure.

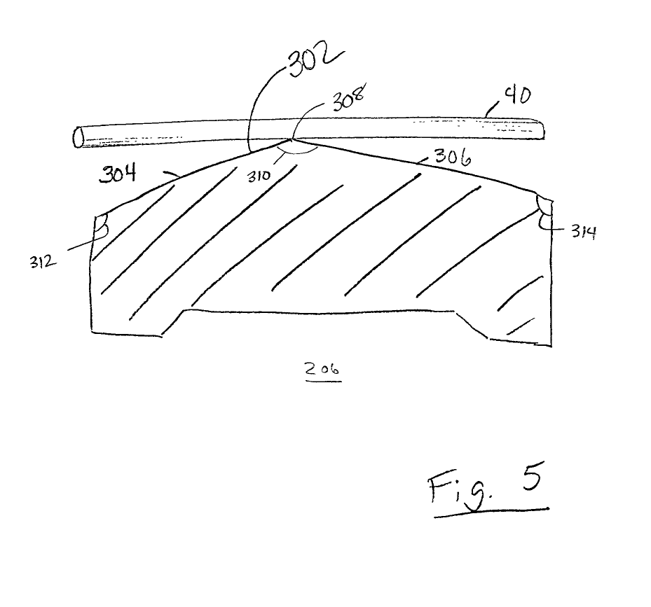

As illustrated in FIGS. 5 and 6, planar surfaces 304, 306 on bracket 300 are disposed in a symmetrical relationship to one another. Specifically, in the preferred embodiment of the present invention, angle 312 (formed between planar surface 304 and side surface 318) and angle 314 (formed between planar surface 306 and side surface 318) are equal to one another. The intersection of planar surfaces 304, 306 forms an angle 310 at apex 308, as illustrated.

As would be understood by those skilled in the art, however, angles 312, 314 need not be equal to one another. It is contemplated that angles 312, 314 may vary from one another so that a greater “tip” angle for tooth 206 may be permitted in one direction over the other. This may be necessary in certain instances where, for example, tooth 206 requires a considerable amount of adjustment during the course of the orthodontic procedure.

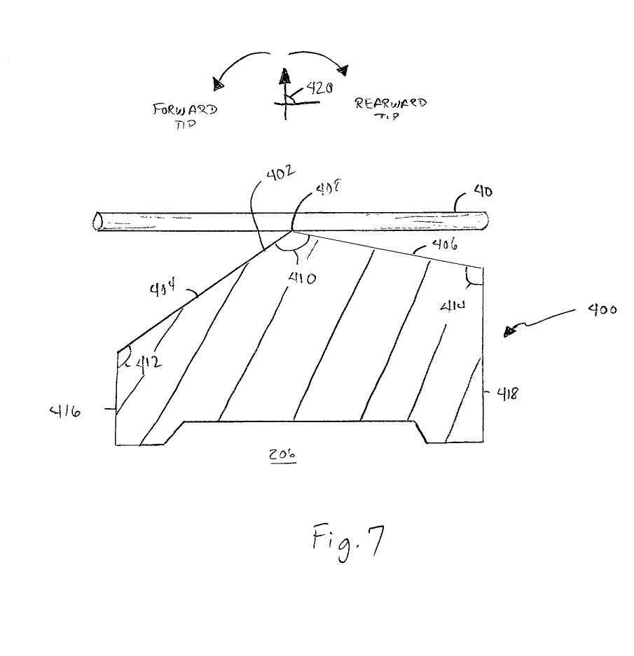

FIG. 7, which depicts a portion of bracket 400, is illustrative of the variation of bracket 300 contemplated within the scope of the present invention, as discussed above. In bracket 400, angle 412 (formed between planar surface 404 and side surface 416) is considerably greater than angle 414 (formed between planar surface 406 and side surface 418). Planar surface 404, therefore, is disposed at a greater angular distance from wire 40 than planar surface 406 of v-shaped surface 402. In this particular example, it is contemplated that tooth 206 will have to be adjusted from its starting angle 420 in a forward tip direction. During the orthodontic procedure, as tooth 206 tips forward, angle 420 will increase until tooth reaches its desired final angle.

In certain instances, it is contemplated that tooth 206 will require considerable correction to its original angle 420 before the orthodontic procedure is concluded. If bracket 300 were used in such an instance, angle 312 would prevent further forward tipping once wire 40 became parallel with planar surface 304. In order to continue adjustment of tooth 206 in such a case, bracket 300 would have to be removed and replaced with another bracket 300. If an extremely large forward tip were required for tooth 206, the removal and replacement of bracket 300 might have to be repeated several times before the orthodontic procedure is completed.

However, where bracket 400 is employed, tooth 206 may tip forwardly to a much greater extent than is possible with bracket 300. Accordingly, for this embodiment of the present invention, it is contemplated that planar surface 404 is disposed a sufficient distance from wire 40 that wire 40 will not come into contact (i.e., become parallel with) planar surface 404 before the orthodontic procedure is complete.

While one particular example of a variation of bracket 300 is illustrated in FIG. 7, the present invention is meant to encompass any variation thereon. For example, planar surface 406 (in the rearward tip direction) may be disposed so that angle 414 is greater than 412. This would be necessary where tooth 206 is to be adjusted in the rearward direction. Moreover, the particular angles 310, 312, 314, 410, 412, 414 selected for brackets 300, 400 may be of any suitable magnitude so long as the corrective orthodontic procedure may be employed.

The foregoing description is meant to be illustrative of the scope of the present invention and is not meant to be limited solely to the embodiments shown and described. To the contrary, those skilled in the art will readily recognize that variations of the embodiments described may be substituted without departing from the scope of the present invention.

What is claimed is:

1. An apparatus, comprising:
an orthodontic bracket defining a wire guide therethrough;
a first planar surface in the wire guide; and
a second planar surface in the wire guide,
wherein the first planar surface is disposed at a predetermined angle from the second planar surface so that the first and second planar surfaces act as stops to limit tipping of the bracket when either planar surface abuts a wire disposed through the wire guide.

2. The apparatus of claim 1, wherein:
the first planar surface is disposed at a first angle with respect to a first side edge of the orthodontic bracket, and
the second planar surface is disposed at a second angle with respect to a second side edge of the orthodontic bracket.

3. The apparatus of claim 2, wherein:
the first angle is substantially equal to the second angle.

4. The apparatus of claim 2, wherein:
the first angle is greater than the second angle.

5. The apparatus of claim 2, wherein:
the first angle is smaller than the second angle.
